(19) United States
(12) Patent Application Publication
(10) Pub. No.: US 2026/0247429 A1
(43) Pub. Date: Aug. 20, 2026

(54) INDICATION OF DEVICE TYPE

(71) Applicant: Nokia Technologies Oy, Espoo (FI)

(72) Inventors: Jie GAO, Hangzhou (CN); Rapeepat RATASUK, Naperville, IL (US); Nitin MANGALVEDHE, Naperville, IL (US)

(21) Appl. No.: 19/471,853

(22) PCT Filed: Apr. 6, 2023
(86) PCT No.: PCT/CN2023/086628

§ 371 Date: Oct. 2, 2025

(51) Int. Cl. H04W 74/00; H04W 74/0833

(52) U.S. Cl. CPC H04W 74/004; H04W 74/0833

(57) ABSTRACT

According to some example embodiments of the present disclosure, there is provided a solution for indication of device type. In the solution, the terminal device determines information associated with a message for a random access. The information may comprise a transmission configuration associated with the message and/or an LCID to be included in the message. The transmission configuration corresponds to a type of the terminal device. The LCID has a value different from another value associated with a further terminal device type. Then, the terminal device transmits the message to the network device based on the information. Based on the transmission configuration and/or the LCID in the message, the network device determines the type of the terminal device.

### FIELDS

Various example embodiments of the present disclosure generally relate to the field of telecommunication and in particular, to methods, apparatuses and computer readable storage medium for indication of device type.

### BACKGROUND

In 5th Generation Mobile Communication Technology (5G) new radio (NR), two contention based random access (CBRA) procedures are supported, namely 4-step random access procedure (i.e., RACH) and 2-step random access procedure.

### SUMMARY

In a first aspect of the present disclosure, there is provided an apparatus. The apparatus comprises at least one processor; and at least one memory storing instructions that, when executed by the at least one processor, cause the apparatus at least to: determine information associated with a message for a random access, wherein the information comprises at least one of: a transmission configuration associated with the message and corresponding to a type of the apparatus, or a logical channel identification to be included in the message, the logical channel identification having a first value different from a second value associated with a further terminal device type, wherein the first value indicates the type of the apparatus; and transmit, to a network device, the message based on the information.

In a second aspect of the present disclosure, there is provided an apparatus. The apparatus comprises at least one processor; and at least one memory storing instructions that, when executed by the at least one processor, cause the apparatus at least to: receive, from a terminal device, a message for a random access; and determine a type of the terminal device based on information associated with the message, wherein the information comprises at least one of: a transmission configuration associated with the message and corresponding to the type of the terminal device, or a logical channel identification, included in the message, having a first value different from a second value associated with a further terminal device type, wherein the first value indicates the type of the terminal device.

In a third aspect of the present disclosure, there is provided a method. The method comprises: determining, at a terminal device, information associated with a message for a random access, wherein the information comprises at least one of: a transmission configuration associated with the message and corresponding to a type of the terminal device, or a logical channel identification to be included in the message, the logical channel identification having a first value different from a second value associated with a further terminal device type, wherein the first value indicates the type of the terminal device; and transmitting, to a network device, the message based on the information.

In a fourth aspect of the present disclosure, there is provided a method. The method comprises: receiving, at a network device from a terminal device, a message for a random access; and determining a type of the terminal device based on information associated with the message, wherein the information comprises at least one of: a transmission configuration associated with the message and corresponding to the type of the terminal device, or a logical channel identification, included in the message, having a first value different from a second value associated with a further terminal device type, wherein the first value indicates the type of the terminal device.

In a fifth aspect of the present disclosure, there is provided an apparatus. The apparatus comprises means for determining information associated with a message for a random access, wherein the information comprises at least one of: a transmission configuration associated with the message and corresponding to a type of the apparatus, or a logical channel identification to be included in the message, the logical channel identification having a first value different from a second value associated with a further terminal device type, wherein the first value indicates the type of the apparatus; and means for transmitting, to a network device, the message based on the information.

In a sixth aspect of the present disclosure, there is provided an apparatus. The apparatus comprises means for receiving, from a terminal device, a message for a random access; and means for determining a type of the terminal device based on information associated with the message, wherein the information comprises at least one of: a transmission configuration associated with the message and corresponding to the type of the terminal device, or a logical channel identification, included in the message, having a first value different from a second value associated with a further terminal device type, wherein the first value indicates the type of the terminal device.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for indicating device type according to some example embodiments of the present disclosure;

FIG. 3 illustrate example parameters for demodulation reference signal (DMRS) according to some example embodiments of the present disclosure;

FIGS. 4A and 4B illustrate example message structures for different device types according to some example embodiments of the present disclosure;

FIGS. 5A and 5B illustrate example message structures for different device types according to some example embodiments of the present disclosure;

FIG. 6 illustrates a signaling chart for indicating device type according to some example embodiments of the present disclosure;

FIG. 7 illustrates a flowchart of a method implemented at a terminal device according to some example embodiments of the present disclosure;

FIG. 8 illustrates a flowchart of a method implemented at a network device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

In embodiments of the present disclosure, a type of a terminal device may be determined based on or correspond to suitable capability, feature, characteristic or release version of the terminal device. Terminal devices of different types may include but not limited to devices complying to different standard or specification versions, and/or devices with different capabilities. As used herein, the terms “type”, “device type”, “type of device”, “terminal device type”, “type of terminal device”, “UE type”, “type of UE”, “category”, “UE category” may be used interchangeably. In an example, a device type may be Release (Rel)-18 reduced capability (RedCap), meaning a RedCap device complying to 3rd Generation Partnership Project (3GPP) Rel-18 specifications; and another device type may be Rel-17 RedCap, meaning a RedCap device supporting 3GPP Rel-17 specifications. In another example, a device type may be a RedCap device with baseband bandwidth reduction and another device type may be a RedCap device with reduced peak rate. In the following, some example embodiments are described with respect to the Rel-17 RedCap and Rel-18 RedCap. However, this is merely for purpose of illustration without any limitation.

FIG. 1 illustrates an example communication environment 100 in which example embodiments of the present disclosure can be implemented. The communication environment 100 may include a terminal device 110. Hereinafter the terminal device 110 may also be referred to as a UE.

The communication environment 100 may further include a network device 120. Hereinafter the network device 120 may also be referred to as a gNB or an eNB, respectively. The network device 120 may communicate with the terminal device 110.

It is to be understood that the number of network devices and terminal devices shown in FIG. 1 is given for the purpose of illustration without suggesting any limitations. The communication environment 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In 5G NR, two CBRA procedures are supported, namely 4-step random access procedure (i.e., RACH) and 2-step random access procedure.

In the 4-step RACH, a UE may send a specific preamble in a Message 1 (Msg1) to the gNB via a physical random access channel (PRACH) using a specific resource called RACH occasion (RO). The gNB may respond to the UE with a random access response (RAR) message, which may also be called as Message 2 (Msg2). The Msg2 may include the detected preamble ID, the time-advance command, a Temporary Cell-Radio Network Temporary Identifier (TC-RNTI) and UL grant for the transmission of Msg3 on Physical Uplink Shared Channel (PUSCH). Then the UE may respond to Msg2 over the scheduled PUSCH with an ID for contention resolution for a Radio Resource Control (RRC) request, which may also be called as Msg3. The gNB may transmits the contention resolution message with the contention-resolution ID for a RRC setup, which may also be referred to as a Message 4 (Msg4).

Upon reception of the Msg4, the UE may send an ACK on a Physical Uplink Control Channel (PUCCH) if its contention-resolution ID is carried by Msg4. This completes the 4-step RACH. Furthermore, prior to Msg1, there is also a preliminary step of sending (at gNB) and receiving (at UE) the synchronization signal block (SSB), comprising DL beam sweeping, which is not formally part of the RACH procedure. As a result of this preliminary step, the UE may select the index of the preferred SSB beam and decode the associated Physical Broadcast Channel (PBCH) for Master Information Block (MIB), subsequently receive and decode the System Information Block (SIB) and so on. This index is also used by UE to identify a suitable RACH occasion (RO) for the preamble transmission (i.e., Msg1), according to the SSB-to-RO mapping conveyed by SIB1. The gNB may use the SSB beam index selected by the UE for the Msg2 transmission.

In the 2-step random access procedure, Msg1 and Msg3 are combined in a MSGA and sent out without waiting for feedback from the gNB in between (traditionally Msg2). Similarly, the gNB may combine Msg2 and Msg4 into Message B (MSGB).

In a random access procedure either the 4-step RACH or 2-step RACH, multiple UEs using a same preamble ID for Msg1 may use same resources to send Msg3, which may cause a decoding failure of Msg3 at gNB due to interference. Furthermore, even if the gNB successfully decodes one Msg3 and responds with the Msg4 including the contention resolution ID that was contained in the Msg3, the other UEs, whose Msg3s had not been decoded by the gNB and detected unsuccessful contention resolution through Msg4, may need to send Msg1 again.

In Rel-17, a RedCap device (which is also referred to as Rel-17 RedCap device or Rel-17 RedCap UE) is specified with the following capabilities as shown in Table 1.

TABLE 1
Reduced capability device

| | Frequency | Frequency |
|---|---|---|
| | range 1 (cmWave) | range 2 (mmWave) |
| Device | 20 MHz | 100 MHz |
| Bandwidth | | |
| Antenna | 1Tx-1Rx | 1Tx-1Rx |
| Configuration | 1Tx-2Rx (optional) | 1Tx-2Rx (optional) |
| Downlink | Yes for device with | Yes for device with |
| MIMO Support | 2Rx branches | 2Rx branches |
| Duplex | FD-FDD, HD-FDD, | TDD |
| Operation | TDD | |
| Maximum | DL: 256-QAM | DL: 64-QAM |
| Modulation | (optional), 64-QAM | UL: 64-QAM |
| | mandatory | |
| | UL: 64-QAM | |
| Peak Data Rate | FD-FDD, 1Rx: | TDD 50:50 DL/UL |
| | 85 Mbps DL/91 Mbps | split, 1Rx: 213 |
| | UL | Mbps DL, 228 |
| | TDD 50:50 DL/UL | Mbps UL |
| | split, 1Rx: 42 Mbps | |
| | DL, 45 Mbps UL | |

In Rel-18, another Reduced Capability device (which is also referred to as Rel-18 RedCap device, or Rel-18 RedCap UE, or eRedCap device) that is a lower-tier device between massive IoT and the Rel-17 RedCap devices is introduced. The Rel-18 RedCap device may have reduced baseband bandwidth and/or reduced peak data rate. The Rel-18 RedCap device with reduced baseband bandwidth is capable of processing or transmitting only subset of PRBs (e.g. 25 PRBs for 15 kHz sub-carrier spacing and 12 PRBs for 30 kHz sub-carrier spacing) for unicast transmission. The supported peak data rate for the new Rel-18 devices is around 10 Mbps. In a solution, the Rel-17 RedCap devices can be identified in Msg1 or Msg3 (i.e., early identification or early indication) so that the gNB can handle them appropriately. It is expected that the Rel-18 RedCap devices will also support separate early identification in Msg1 or Msg3.

In a solution, UE type can be identified in Msg1 based on partitioning preambles for different UE types, e.g., Small Data Transmission (SDT), RedCap, Ultra Reliable Low Latency Communication (URLLC), RACH GROUP A, GROUP B. However, given the increasing number of partitions of the RACH preamble space, the number of Msg1 collisions could increase with improper sizing of the different partitions. When there is a Msg1 collision from multiple UEs that selected the same PRACH preamble, the corresponding UEs also transmit Msg3 in the same resource provided by the RAR resulting in a Msg3 contention. As a result, the increasing number of partitions of the RACH preamble space may cause an increased probability of Msg1 collisions and Msg3 contention.

If for Rel-18 RedCap device, separate logical channel identifications (LCIDs) are specified for the Msg3/MsgA early indication similarly to Rel-17, they would spend 2 additional LCIDs from the very scarce resource (only 6 reserved values after Rel-17) of short LCIDs left in UL-SCH.

Therefore, a new solution is needed to address the approach to early identification of Rel-18 Redcap device, or a way to support other new features that require early identification of UE types.

According to some example embodiments of the present disclosure, there is provided a solution for indication of device type. In the solution, the terminal device determines information associated with a message for a random access. For example, the message may be Msg3 or MSGA. The information may comprise a transmission configuration associated with the message and/or an LCID to be included in the message. The transmission configuration corresponds to a type of the terminal device. The LCID has a value different from another value associated with a further terminal device type. Then, the terminal device transmits the message to the network device based on the information. The network device receives the message. Based on the transmission configuration and/or the LCID in the message, the network device determines the type of the terminal device. In this way, the type of the terminal device can be identified or known by the network device early. By early identification of the device type, the network device can handle collision early.

Example embodiments of the present disclosure will be described in detail below with reference to the accompanying drawings.

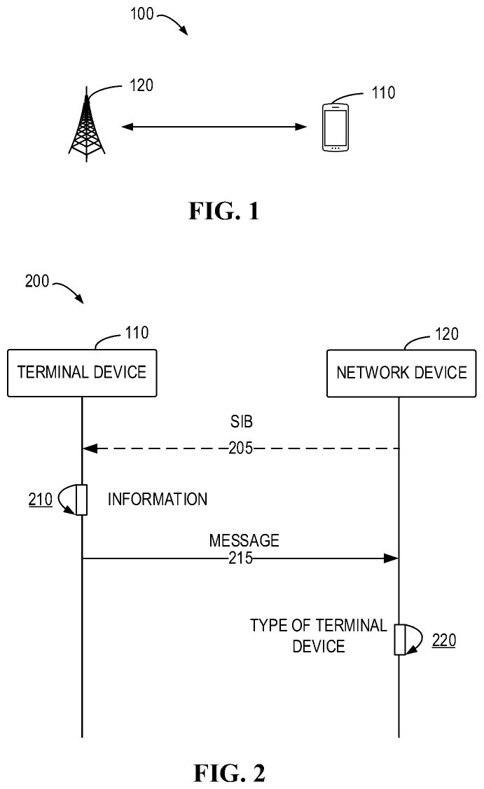

Reference is now made to FIG. 2, which shows a signaling chart 200 for communication according to some example embodiments of the present disclosure. As shown in FIG. 2, the signaling chart 200 involves the terminal device 110 and the network device 120. For the purpose of discussion, reference is made to FIG. 1 to describe the signaling chart 200.

The terminal device 110 determines (210) information associated with a message for a random access. In some example embodiments, the message may be Msg3 in the 4-step RACH. This may mean that the process shown in FIG. 2 take place during the 4-step RACH. In some example embodiments, the message may be MSGA in the 2-step RACH. This may mean that the process shown in FIG. 2 take place during the 2-step RACH.

The determined information may comprise a transmission configuration associated with the message and the transmission configuration corresponds to a type of the terminal device 110. Alternatively, or in addition, the determined information may comprise an LCID to be included in the message. The LCID has a first value different from a second value associated with a further terminal device type. The first value may indicate the type of the terminal device 110. In other words, such information can be used to indicate the type of the terminal device 110 to the network device 120.

In some example embodiments, the transmission configuration may be defined as a default configuration corresponding to the terminal device type. In other words, the transmission configuration may be defined in the technical specification. For example, terminal devices of different types may use corresponding transmission configurations to transmit the Msg3 and/or MSGA.

Alternatively, in some example embodiments, the transmission configuration may be configured by the network device 120. As shown in FIG. 2, the network device 120 may transmit (205) the transmission configuration in a system information block (SIB) to the terminal device 110. For example, the SIB may include transmission configurations corresponding to different device types. Based on the SIB, the terminal device 110 may determine which transmission configuration to use for Msg3 and/or MSGA.

The terminal device 110 transmits (215) the message to the network device 120 based on the determined information. For example, in the 4-step RACH, after receiving UL grant in RAR, Msg3 is transmitted. For another example, in the 2-step RACH, MSGA is transmitted.

The network device 120 receives the message from the terminal device 110. Based on the information associated with the received message, the network device 120 determines the type of the terminal device 110. For example, the network device 120 may identify the type of the terminal device based on the transmission configuration associated with the message. For another example, the network device 120 may identify the type of the terminal device 110 at least based on the value of the LCID included in the message.

A general process is described above. To better understand the solution, some more example embodiments regarding the transmission configuration and the LCID are described now.

In some example embodiments, the transmission configuration may comprise a reference signal (RS) configuration for transmitting a DMRS associated with the message. Accordingly, the terminal device 110 may transmit the DMRS to the network device 120 using the RS configuration. That is, RS configurations may be used to distinguish device types.

As an example, when transmitted PUSCH is neither scheduled by downlink control information (DCI) format 0_1/0_2 with Cyclic Redundancy Check (CRC) scrambled by cell-RNTI (C-RNTI), configured scheduled (CS)-RNTI, a semi-persistent channel state information (SP-CSI)-RNTI or a modulation and coding scheme-cell (MCS-C)-RNTI, nor corresponding to a configured grant, nor being a PUSCH for Type-2 random access procedure, the UE shall use a single symbol front-loaded DMRS of configuration type 1 on DMRS port 0 and the remaining REs not used for DMRS in the symbols are not used for any PUSCH transmission except for PUSCH with allocation duration of 2 or less OFDM symbols with transform precoding disabled. Additional DMRS can be transmitted according to the scheduling type and the PUSCH duration.

Given the above, in some example embodiments, the RS configuration may comprise an antenna port for the DMRS associated with the message. The antenna port for the DMRS is also referred to as a DMRS antenna port. In other words, different device types may correspond to different DMRS antenna port. Terminal devices of different types use corresponding DMRS antenna port for Msg3 or MSGA. Based on the DMRS antenna port of the received Msg3 or MSGA, the network device 110 can identify the type of the transmitting terminal device.

The configuration of a DMRS antenna port may be predefined in the technical specification or may be broadcasted in a system information block (SIB) by the network device 120. Taking early identification of Rel-18 RedCap UE in MSGA PUSCH in the case of the 2-step RACH procedure as an example. In this example, PRACH-based early identification of Rel-17 and Rel-18 RedCap UE is configured, and different sets of DMRS antenna ports may be configured for Rel-17 RedCap UE (for example, using the existing MSGA DMRS configuration) and Rel-18 RedCap UE for example (using a new MSGA DMRS configuration). In this way, the currently supported DMRS antenna ports (with PUSCH DMRS configuration type 1) can be shared between the two UE types.

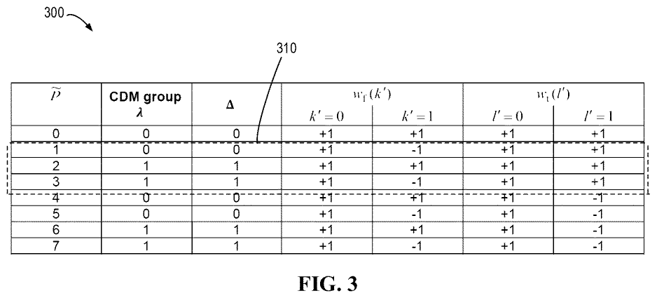

FIG. 3 shows example parameters for DMRS according to some example embodiments of the present disclosure. The parameter p represents a DMRS antenna port, the parameter λ represents the Code Division Multiplexing (CDM) group, the parameters w_{f}(k′), wₜ(l′), and A are used for precoding and mapping to physical resources. For example, as shown in FIG. 3, ports {0} may be configured for Rel-17 RedCap UEs (with the existing MSGA DMRS configuration) and ports {1, 2, 3 . . . } in the block 310 may be configured for eRedCap UE (with a new MSGA DMRS configuration).

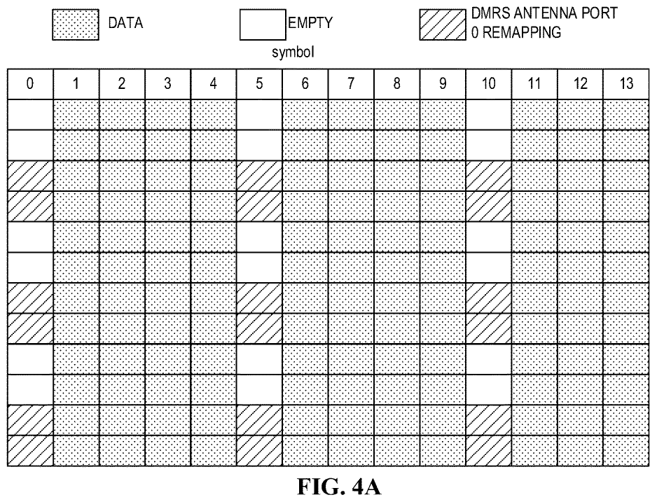

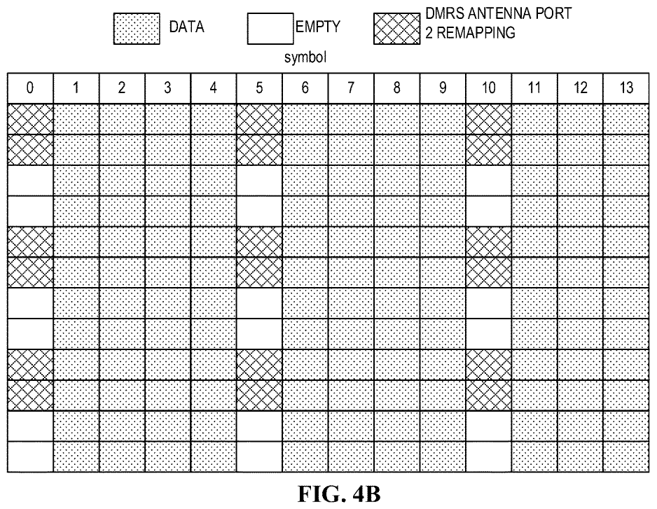

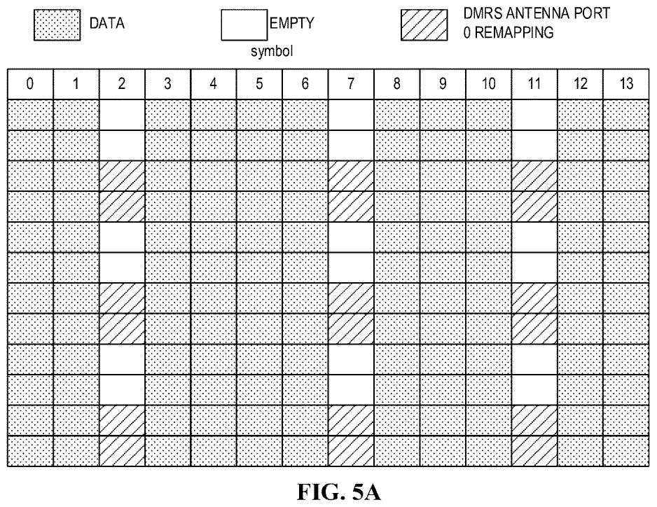

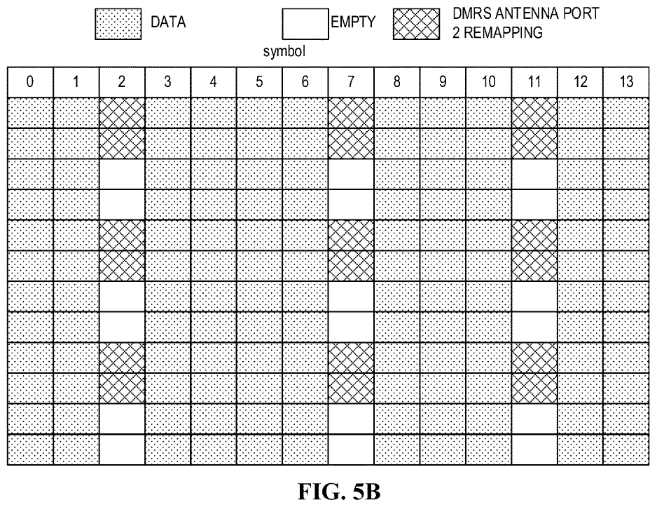

FIGS. 4A, 4B, 5A, 5B show example message structures for different device capabilities. Specifically, FIGS. 4A and 4B show type B 14 symbol Msg3, and FIGS. 5A and 5B show type A 14 symbol Msg3. For example, the Rel-17 RedCap UE may use DMRS antenna port 0 and the structure of Msg3 is shown as FIG. 4A or FIG. 5A. While the Rel-18 RedCap UE may use DMRS antenna port 2 and the structure of Msg3 is shown as FIG. 4B or FIG. 5B. Therefore, based on the decoding of the DMRS associated with Msg3, the network device 120 can distinguish the Rel-17 RedCap UE and the Rel-18 RedCap UE.

In some example embodiment, the Msg3/MSGA DMRS port configuration may be broadcast in SIB1. A new parameter may be included in the SIB 1 to indicate rule for binding with UE types or UE feature. For example, port {0} are configured for Rel-17 RedCap UEs (with the existing MSGA DMRS configuration) and ports {1, 2, 3 . . . } are configured for eRedCap UE (with a new MSGA DMRS configuration) based on the parameters defined in SIB 1. For example, the parameter “MsgA-PUSCH-Config->msgA-DMRS-Config-r16” is configured for the RedCap UE and e.g., the parameter “MsgA-PUSCH-Config->msgA-DMRS-Config-r18” is configured for the eRedCap UE. This separation can be defined through specifying which DMRS CDM groups can be used by the eRedCap UE. For example, the DMRS CDM groups used by the eRedCap UE may be orthogonal to the DMRS CDM groups specified for the legacy UE in the existing rule.

Alternatively, in some example embodiments, the Msg3/MSGA DMRS port configuration may be predefined in the technical specification. UE types or UE features binding with DMRS antenna port can be defined. For example, the technical specification may define that eRedCap UEs use DMRS antenna port 2 for Msg3 and/or MSGA, and that eRedCap UEs with SDT feature use DMRS antenna port 3 for Msg3 and/or MSGA. It is noted that this binding between UE types and DMRS antenna ports is an example without any limitation.

In such example embodiments, if different antenna ports associated with different UE types are detected in the same Msg3 resource, an Msg1 conflict has occurred. The network device 120 can identify conflict and can further optimize retransmission. In some example embodiments, the DMRS antenna port can be combined with partitioning of PRACH preambles for more granular identification and resource savings.

In the example embodiments described above, DMRS antenna ports are used to differentiate between the Rel-17 RedCap UE and Rel-18 RedCap UE. Addition or alternative differentiation way may be possible. These alternatives may rely on differentiating the terminal device types via different physical-layer characteristics.

Alternatively, or in addition, in some example embodiments, the RS configuration may comprise a first sequence for generating the DMRS, which is also referred to as DMRS sequence. For example, Rel-17 RedCap UE may use a certain sequence to generate the DMRS associated with Msg3 and/or MSGA, while the Rel-18 RedCap UE may use a different sequence to generate the DMRS. In this way, the network device 120 can differentiate between the Rel-17 RedCap UE and Rel-18 RedCap UE based on the DMRS sequences. In such example embodiments, the network device 120 may identify the device type of the transmitting terminal device based on the DMRS sequence of the received DMRS associated with Msg3 and/or MSGA.

Alternatively, or in addition, in some example embodiments, the RS configuration may comprise a first sequence starting point for generating the DMRS. A sequence starting point is also referred to as sequence initialization (Cᵢₙᵢₜ). Terminal devices of different types may use the same DMRS sequence but use different sequence initializations. In such example embodiments, the network device 120 may identify the device type of the transmitting terminal device based on the initialization of the DMRS sequence.

Alternatively, or in addition, in some example embodiments, the transmission configuration may comprise a scrambling configuration for the message. Accordingly, the message (for example, Msg3 and/or MSGA) is scrambled based on the scrambling configuration. Then, the network device 120 may identify the device type of the transmitting terminal device based on which descrambling configuration is used to descramble Msg3 and/or MSGA.

In some example embodiments, the scrambling configuration may comprise a second sequence for scrambling the message, which is also referred to as a scrambling sequence. Terminal devices of different types may use the different scrambling sequences to scramble Msg3 and/or MSGA. In an example, the Rel-17 RedCap UE may use a scrambling sequence based on RA-RNTI, while the Rel-18 RedCap UE may use a different sequence. In such example embodiments, the network device 120 may identify the device type of the transmitting terminal device based on which descrambling sequence is used to descramble Msg3 and/or MSGA.

In some example embodiments, the RS configuration may comprise a second sequence starting point for scrambling the message. A sequence starting point is also referred to as sequence initialization (Cᵢₙᵢₜ). Terminal devices of different types may use the same scrambling sequence but use different sequence initializations of the same scrambling sequence. In such example embodiments, the network device 120 may identify the device type of the transmitting terminal device based on the initialization of the descrambling sequence used to descramble Msg3 and/or MSGA.

Generally, the differentiation as described above can benefit from the use of Msg1 early indication to tell the network device that this is a RedCap UE (although it's not known whether it's Rel-17 or Rel-18). This would prevent the network device from having to perform two types of physical-layer processing on all the Msg3 transmissions.

In the example embodiments described above, the transmission configuration is used to indicate the device type of the terminal device 110.

Alternatively, or in addition, in some example embodiments, a preamble may be used in combination with a value of the LCID in the message to indicate the device type. Specifically, the terminal device 110 may transmit a preamble for the random access to the network device 120. The preamble corresponds to a plurality of types of terminal devices comprising the device type of the terminal device 110 and a further terminal device type. For example, in the 4-step RACH, the preamble is transmitted in Msg1. For another example, in the 2-step RACH, the preamble is transmitted in MSGA. Then, in the message transmitted to the network device 120, a value (which is also referred to as a first value) of the LCID is different from another value (which is also referred to as a second value) associated with the further device type.

As an example, in the 4-step RACH, the gNB may use Msg1 early indication and Msg3 LCID to determine whether UE is a Rel-18 RedCap UE. Msg1 early indication identifying device type may be based on partitioning preambles for different device types, e.g., SDT, REDCAP, URLLC, RACH GROUP A, GROUP B. Specifically, RedCap UEs may select a preamble for transmitting in Msg1 from a subset of the preambles. Accordingly, if the gNB receives a preamble from the subset allocated for the RedCap UEs, the gNB can determine that the transmitting UE is a RedCap UE, but the gNB does not know whether the transmitting UE is Rel-18 or Rel-17.

In this case, the LCID of the Rel-18 UE can be set by the gNB to a reserved value or to another value not used the by Rel-17 RedCap UE. Since Msg1 indicates that this is a RedCap UE, this can be used to determine that the UE is a Rel-18 UE without having to permanently reserve an LCID for Rel-18 RedCap UE. As an example without any limitation, Table 2 shows values of LCID for UL-shared channel (SCH). As can be seen from Table 2, the codepoints/indexes “35” and “36” are used for Rel-17 RedCap UE. Then, for the Rel-18 RedCap UE, the value of the LCID in Msg3 and/or MSGA can be set as any value other than “35” and “36”. Since the message in the UL-SCH is received in a resource in which Msg3 is scheduled, the gNB can determine that it is Msg3 from a RedCap UE that is not Rel-17, i.e., a Rel-18 RedCap UE. As an example, the codepoints/indexes “0” and “52” (i.e., the values associated with CCCH messages for non-RedCap UEs) are reused for the Rel-18 RedCap UE.

TABLE 2
Values of LCID for UL-SCH

| Codepoint/ | |
|---|---|
| Index | LCID values |
| 0 | CCCH of size 64 bits (referred to as “CCCH1” in |
| | TS 38.331 [5]), except for a RedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits (referred to as “CCCH” in |
| | TS 38.331 [5]) for a RedCap UE |
| 36 | CCCH of size 64 bits (referred to as “CCCH1” in |
| | TS 38.331 [5]) for a RedCap UE |
| 37-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in |
| | TS 38.331 [5]), except for a RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

Such example embodiments do not require changes in physical-layer processing but relies on higher-layer (e.g. MAC) processing (i.e. looking at message content). This method is less complicated at the network.

Now taking the 4-step RACH as an example to illustrate an RA procedure with an indication of the device type. However, it is noted that the concept can be applied to 2-step RACH.

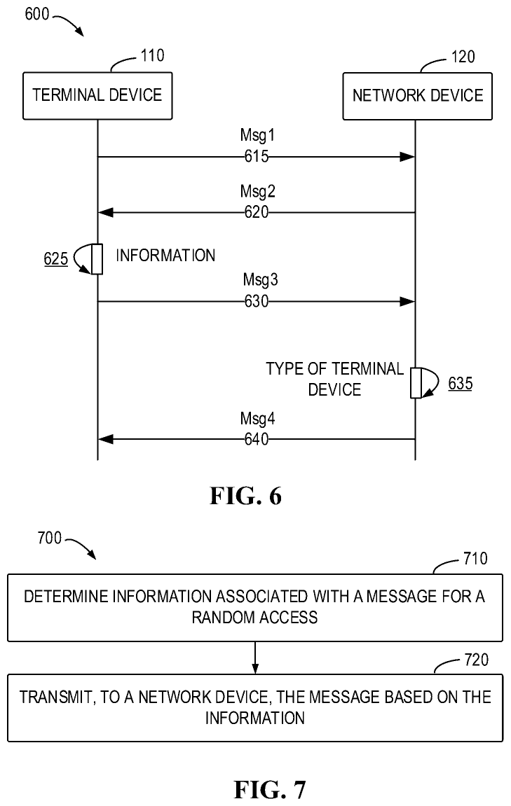

FIG. 6 shows a signaling chart 600 for indicating device type. As shown in FIG. 6, the signaling chart 600 involves the terminal device 110 and the network device 120. For the purpose of discussion, reference is made to FIG. 1 to describe the signaling chart 600. Chart 600 may be considered as an implantation of chart 200.

The terminal device 110 may send (615) a specific preamble in a Msg1 to the network device 120. In some example embodiments, the preamble may be selected from a subset of preambles corresponding to some device types, for example RedCap UEs.

The network device 120 may transmit (620) Msg2 to the terminal device 110. The Msg2 may include the detected preamble ID, the time-advance command, a TC-RNTI and UL grant for the transmission of Msg3 on PUSCH.

The terminal device 110 determines (625) information associated with Msg3. In some example embodiments, the information may include a transmission configuration associated with Msg3 and corresponding to the type of the terminal device 110. The transmission configuration is similar as that described above and thus description thereof is not repeated.

The terminal device 110 transmits (630) Msg3 to the network device 120 based on the determined information. Upon receiving the Msg3, the network device 120 determines (635) the device type of the terminal device 110 based on information associated with Msg3. For example, based on the preamble in Msg1 corresponding to RedCap UEs and the value of LCID being different from “35” and “36” for Rel-17 RedCap UE, the network device 120 may determine that the terminal device 120 is a Rel-18 RedCap UE. For another example, based on that the DMRS antenna port 2 is used, the network device 120 may determine that the terminal device 120 is a Rel-18 RedCap UE.

Then the network device 120 transmits (640) Msg4 to the terminal device 110. The network device 120 may schedule Msg4 based on the determined device type or feature.

The proposed solution is easy for further expanded to identify a UE with a new feature. The proposed solution does not require to further split Msg1 preamble number for UE identification and is compatible with legacy UE.

Given the increasing partitioning of the RACH preamble space, the number of collisions could increase. The solution could help to reduce RACH load in the network. Also, gNB UL PHY capability of processing RACH preambles per RACH occasion is limited and hence reducing overall RACH load is beneficial.

FIG. 7 shows a flowchart of an example method 700 implemented at a terminal device in accordance with some example embodiments of the present disclosure. For the purpose of discussion, the method 700 will be described from the perspective of the terminal device 110 in FIG. 1.

At block 710, the terminal device 110 determines information associated with a message for a random access. The information comprises at least one of: a transmission configuration associated with the message and corresponding to a type of the terminal device 110, or a logical channel identification to be included in the message. The logical channel identification has a first value different from a second value associated with a further terminal device type. The first value may indicate the type of the terminal device 110.

At block 720, the terminal device 110 transmits, to a network device 120, the message based on the information.

In some example embodiments, the transmission configuration comprises a reference signal configuration for transmitting a demodulation reference signal associated with the message. The terminal device 110 may transmit the demodulation reference signal to the network device 120 using the reference signal configuration.

In some example embodiments, the reference signal configuration comprises at least one of: an antenna port for the demodulation reference signal, a first sequence for generating the demodulation reference signal, or a first sequence starting point for generating the demodulation reference signal.

In some example embodiments, the transmission configuration comprises a scrambling configuration for the message, and the transmitted message is scrambled based on the scrambling configuration.

In some example embodiments, the scrambling configuration comprises at least one of: a second sequence for scrambling the message, or a second sequence starting point for scrambling the message.

In some example embodiments, in the transmitted message, the first value of the logical channel identification is different from the second value associated with the further type. The terminal device 110 may further transmit a preamble for the random access to the network device 120. The preamble corresponds to a plurality of types of terminal devices comprising the type of the terminal device 110 and the further terminal device type.

In some example embodiments, the transmission configuration is defined as a default configuration corresponding to the type of the terminal device 110.

In some example embodiments, the terminal device 110 may receive, from the network device 120, the transmission configuration in a system information block.

In some example embodiments, the message comprises at least one of: a MSGA in a two-step random access procedure, or a Msg3 in a four-step random access procedure.

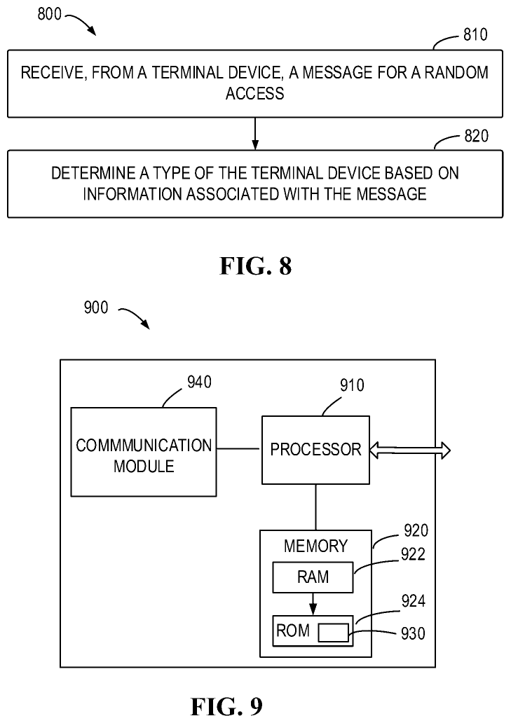

FIG. 8 shows a flowchart of an example method 800 implemented at a network device in accordance with some example embodiments of the present disclosure. For the purpose of discussion, the method 800 will be described from the perspective of the network device 120 in FIG. 1.

At block 810, the network device 120 receives, from a terminal device 110, a message for a random access.

At block 820, the network device 120 determines a type of the terminal device 110 based on information associated with the message. The information comprises at least one of: a transmission configuration associated with the message and corresponding to the type of the terminal device 110, or a logical channel identification, included in the message, having a first value different from a second value associated with a further terminal device type. The first value may indicate the type of the terminal device 120.

In some example embodiments, the transmission configuration comprises a reference signal configuration for receiving a demodulation reference signal associated with the message.

In some example embodiments, the reference signal configuration comprises at least one of: an antenna port for the demodulation reference signal, a first sequence for decoding the demodulation reference signal, or a first sequence starting point for decoding the demodulation reference signal.

In some example embodiments, the transmission configuration comprises a scrambling configuration for the message, and the message is descrambled based on the scrambling configuration.

In some example embodiments, the scrambling configuration comprises at least one of: a second sequence for descrambling the message, or a second sequence starting point for descrambling the message.

In some example embodiments, the network device 120 may receive a preamble for the random access from the terminal device; based on a determination that the preamble corresponds to a plurality of types of terminal devices, the network device 120 may determine whether the first value of the logical channel identification is different from the second value associated with the further terminal device type; and based on a determination that the first value of the logical channel identification is different from the second value associated with the further type, the network device 120 may determine the type of the terminal device 110.

In some example embodiments, the transmission configuration is defined as a default configuration corresponding to the type of the terminal device 110.

In some example embodiments, the network device 120 may transmit, to the terminal device 110, the transmission configuration in a system information block.

In some example embodiments, the message comprises at least one of: a MSGA in a two-step random access procedure, or a Msg3 in a four-step random access procedure.

In some example embodiments, an apparatus capable of performing any of the method 700 (for example, the terminal device 110 in FIG. 1) may comprise means for performing the respective operations of the method 700. The means may be implemented in any suitable form. For example, the means may be implemented in a circuitry or software module. The apparatus may be implemented as or included in the terminal device 110 in FIG. 1.

In some example embodiments, the apparatus comprises means for determining information associated with a message for a random access, wherein the information comprises at least one of: a transmission configuration associated with the message and corresponding to a type of the terminal device, or a logical channel identification to be included in the message, the logical channel identification having a first value different from a second value associated with a further terminal device type, wherein the first value indicates the type of the terminal device; and means for transmitting, to a network device, the message based on the information.

In some example embodiments, the transmission configuration comprises a reference signal configuration for transmitting a demodulation reference signal associated with the message. The apparatus comprises means for transmitting the demodulation reference signal to the network device using the reference signal configuration.

In some example embodiments, the reference signal configuration comprises at least one of: an antenna port for the demodulation reference signal, a first sequence for generating the demodulation reference signal, or a first sequence starting point for generating the demodulation reference signal.

In some example embodiments, the transmission configuration comprises a scrambling configuration for the message, and the transmitted message is scrambled based on the scrambling configuration.

In some example embodiments, the scrambling configuration comprises at least one of: a second sequence for scrambling the message, or a second sequence starting point for scrambling the message.

In some example embodiments, in the transmitted message, the first value of the logical channel identification is different from the second value associated with the further terminal device type. The apparatus comprises means for transmitting a preamble for the random access to the network device, wherein the preamble corresponds to a plurality of types of terminal devices comprising the type of the terminal device and the further terminal device type.

In some example embodiments, the transmission configuration is defined as a default configuration corresponding to the terminal device type.

In some example embodiments, the apparatus comprises means for receiving, from the network device, the transmission configuration in a system information block.

In some example embodiments, the message comprises at least one of: a MSGA in a two-step random access procedure, or a Msg3 in a four-step random access procedure.

In some example embodiments, the apparatus further comprises means for performing other operations in some example embodiments of the method 700 or the terminal device 110. In some example embodiments, the means comprises at least one processor; and at least one memory storing instructions that, when executed by the at least one processor, cause the performance of the apparatus.

In some example embodiments, an apparatus capable of performing any of the method 800 (for example, the network device 120 in FIG. 1) may comprise means for performing the respective operations of the method 800. The means may be implemented in any suitable form. For example, the means may be implemented in a circuitry or software module. The apparatus may be implemented as or included in the network device 120 in FIG. 1.

In some example embodiments, the apparatus comprises means for receiving, from a terminal device, a message for a random access; and means for determining a type of the terminal device based on information associated with the message, wherein the information comprises at least one of: a transmission configuration associated with the message and corresponding to the type of the terminal device, or a logical channel identification, included in the message, having a first value different from a second value associated with a further terminal device type, wherein the first value indicates the type of the terminal device.

In some example embodiments, the transmission configuration comprises a reference signal configuration for receiving a demodulation reference signal associated with the message.

In some example embodiments, the reference signal configuration comprises at least one of: an antenna port for the demodulation reference signal, a first sequence for decoding the demodulation reference signal, or a first sequence starting point for decoding the demodulation reference signal.

In some example embodiments, the transmission configuration comprises a scrambling configuration for the message, and the message is descrambled based on the scrambling configuration.

In some example embodiments, the scrambling configuration comprises at least one of: a second sequence for descrambling the message, or a second sequence starting point for descrambling the message.

In some example embodiments, the apparatus comprises means for receiving a preamble for the random access from the terminal device; means for based on a determination that the preamble corresponds to a plurality of types of terminal devices, determining whether the first value of the logical channel identification is different from the second value associated with the further terminal device type; and means for based on a determination that the first value of the logical channel identification is different from the second value associated with the further type, determining the type of the terminal device.

In some example embodiments, the transmission configuration is defined as a default configuration corresponding to the type of the terminal device.

In some example embodiments, the apparatus comprises means for transmitting, to the terminal device, the transmission configuration in a system information block.

In some example embodiments, the message comprises at least one of: a MSGA in a two-step random access procedure, or a Msg3 in a four-step random access procedure.

In some example embodiments, the apparatus further comprises means for performing other operations in some example embodiments of the method 800 or the network device 120. In some example embodiments, the means comprises at least one processor; and at least one memory storing instructions that, when executed by the at least one processor, cause the performance of the apparatus.

FIG. 9 is a simplified block diagram of a device 900 that is suitable for implementing example embodiments of the present disclosure. The device 900 may be provided to implement a communication device, for example, the terminal device 110 or the network device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

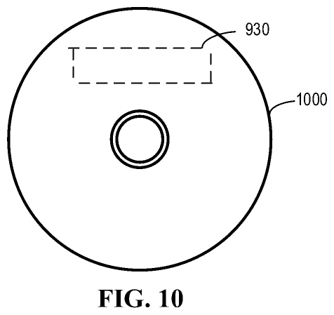

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
determine information associated with a message for a random access, wherein the information comprises at least one of:
a transmission configuration associated with the message and corresponding to a type of the apparatus, or
a logical channel identification to be included in the message, the logical channel identification having a first value different from a second value associated with a further terminal device type, wherein the first value indicates the type of the apparatus; and
transmit, to a network device, the message based on the information.

2. The apparatus of claim 1, wherein the transmission configuration comprises a reference signal configuration for transmitting a demodulation reference signal associated with the message, and
the at least one memory storing instructions that, when executed by the at least one processor, further cause the apparatus to:
transmit the demodulation reference signal to the network device using the reference signal configuration.

3. The apparatus of claim 2, wherein the reference signal configuration comprises at least one of:
an antenna port for the demodulation reference signal,
a first sequence for generating the demodulation reference signal, or
a first sequence starting point for generating the demodulation reference signal.

4. The apparatus of claim 1, wherein the transmission configuration comprises a scrambling configuration for the message, and the transmitted message is scrambled based on the scrambling configuration.

5. The apparatus of claim 4, wherein the scrambling configuration comprises at least one of:
a second sequence for scrambling the message, or
a second sequence starting point for scrambling the message.

6. The apparatus of claim 1, wherein in the transmitted message, the first value of the logical channel identification is different from the second value associated with the further terminal device type, and the at least one memory storing instructions that, when executed by the at least one processor, further cause the apparatus to:
transmit a preamble for the random access to the network device, wherein the preamble corresponds to a plurality of types of terminal devices comprising the type of the apparatus and the further terminal device type.

7. The apparatus of claim 1, wherein the transmission configuration is defined as a default configuration corresponding to the type of the apparatus.

8. The apparatus of claim 1, wherein the at least one memory storing instructions that, when executed by the at least one processor, further cause the apparatus to:
receive, from the network device, the transmission configuration in a system information block.

9. The apparatus of claim 14, wherein the message comprises at least one of:
a MSGA in a two-step random access procedure, or
a Msg3 in a four-step random access procedure.

10. An apparatus comprising:
at least one processor; and
at least one memory storing instructions that, when executed by the at least one processor, cause the apparatus at least to:
receive, from a terminal device, a message for a random access; and
determine a type of the terminal device based on information associated with the message, wherein the information comprises at least one of:
a transmission configuration associated with the message and corresponding to the type of the terminal device, or
a logical channel identification, included in the message, having a first value different from a second value associated with a further terminal device type, wherein the first value indicates the type of the terminal device.

11. The apparatus of claim 10, wherein the transmission configuration comprises a reference signal configuration for receiving a demodulation reference signal associated with the message.

12. The apparatus of claim 11, wherein the reference signal configuration comprises at least one of:
an antenna port for the demodulation reference signal,
a first sequence for decoding the demodulation reference signal, or
a first sequence starting point for decoding the demodulation reference signal.

13. The apparatus of claim 10, wherein the transmission configuration comprises a scrambling configuration for the message, and the message is descrambled based on the scrambling configuration.

14. The apparatus of claim 13, wherein the scrambling configuration comprises at least one of:
a second sequence for descrambling the message, or
a second sequence starting point for descrambling the message.

15. The apparatus of claim 10, wherein the at least one memory storing instructions that, when executed by the at least one processor, cause the apparatus to:
receive a preamble for the random access from the terminal device;
based on a determination that the preamble corresponds to a plurality of types of terminal devices, determine whether the first value of the logical channel identification is different from the second value associated with the further terminal device type; and
based on a determination that the first value of the logical channel identification is different from the second value associated with the further type, determine the type of the terminal device.

16. The apparatus of claim 10, wherein the transmission configuration is defined as a default configuration corresponding to the type of the terminal device.

17. The apparatus of claim 10, wherein the at least one memory storing instructions that, when executed by the at least one processor, cause the apparatus to:
transmit, to the terminal device, the transmission configuration in a system information block.

18. The apparatus of claim 10, wherein the message comprises at least one of:
a MSGA in a two-step random access procedure, or
a Msg3 in a four-step random access procedure.

19. A method comprising:
determining, at a terminal device, information associated with a message for a random access, wherein the information comprises at least one of:
a transmission configuration associated with the message and corresponding to a type of the terminal device, or
a logical channel identification to be included in the message, the logical channel identification having a first value different from a second value associated with a further terminal device type, wherein the first value indicates the type of the terminal device; and
transmitting, to a network device, the message based on the information.

20-44. (canceled)
